(19) United States
(12) Patent Application Publication
(10) Pub. No.: US 2016/0131359 A1
(43) Pub. Date: May 12, 2016

(54) FLOATING CANDLE DISK

(71) Applicants: Tami Trew, Martinez, CA (US); Kelly Martin, San Luis Obispo, CA (US)

(72) Inventors: Tami Trew, Martinez, CA (US); Kelly Martin, San Luis Obispo, CA (US)

(21) Appl. No.: 14/933,504

(22) Filed: Nov. 5, 2015

Related U.S. Application Data
(60) Provisional application No. 62/077,279, filed on Nov. 9, 2014.

(51) Int. Cl. F21V 35/00

(52) U.S. Cl. CPC F21V 35/00

(57) ABSTRACT

An inexpensive disk for holding and buoyantly supporting a candle in a beverage, in particular for small birthday candles. The disk is formed of a flat sheet of inexpensive and disposable material with a central aperture having grippers for holding the candle. The disk may be embossed with numbers or letters signifying a special event.

### RELATED APPLICATION INFORMATION

The present application claims priority under 35 U.S.C. §119 to U.S. Provisional Patent Application No. 62/077,279, filed Nov. 9, 2014.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### FIELD OF THE INVENTION

The present application relates to candle holders and, more particularly, to a disk-shaped floating candle holder especially useful for beverage adornment.

### BACKGROUND OF THE INVENTION

Floating candle holders are known. Such devices typically include plastic dishes which float while supporting a candle thereby preventing the liquid from extinguishing the candle flame. Such devices are used for decoration and are fabricated in a multitude of shapes and sizes. However, the currently available devices typically support votive candles.

Moreover, as the purpose of the current floating candle holders is primarily decorative in nature, the current floating candle holders lack many novel features which can be used to expand their marketability. For example, the current candle holders are not designed to hold conventional birthday candles. That is, conventional birthday candles (i.e., narrow cylindrical candles), unlike votive candles, need external support to maintain an upright position. For example, when used with a cake, birthday candles must be inserted into the cake so that they stand upright.

U.S. Patent Publication No. 2006/0227541 discloses a birthday candle holder with various whimsical shapes. However, the holder includes a base or dish, a three-dimensional candle support and means for attaching the three-dimensional candle support to the dish, all of which are relatively bulky and though ostensibly disposable are quite wasteful in terms of materials used.

Consequently, there continues to be a need for floating candle holders which support conventional birthday candles. In addition, there is a need for a simple floating candle holder which can be easily deployed and is disposable.

### SUMMARY OF THE INVENTION

An improved floating candle holder includes a disk for holding and buoyantly supporting a candle in a beverage. The disk may be formed of a flat sheet of inexpensive and disposable material with a central aperture having grippers for holding the candle. The disk may be embossed or printed with numbers or letters signifying a special event.

One embodiment of the floating candle holder includes a simple two-dimensional sheet formed into a disk with an insertion aperture in the center sized to receive and hold a conventional birthday candle. The insertion aperture may be round or otherwise configured to apply a frictional holding force on the candle. For instance, a series of cuts radiating outward from a circular central aperture may be provided, with the aperture being sized smaller than the candle diameter so that the segments between the cuts flex outward and apply a holding force to the candle. Another example is a star-shaped insertion aperture with the inner apices of the star describing a circle that is smaller than the candle diameter. The insertion aperture is desirably located at a point of central buoyancy in the sheet so that the assembly of candle and sheet is balanced while floating in the fluid and the candle remains vertical.

In one embodiment, the sheet is cut into a circular disk, though other shaped disks are contemplated, preferably symmetric about a point of central buoyancy. For instance, the sheet may be formed as a regular polygons such as an octogonal disk or hexagonal disk. Desirably, the sheet material permits the addition of printing or embossing of various designs, logos or text, and may also incorporate a bar code or other such identifier for use as a gift card. The material of the disk is preferably inexpensive and disposable. The sheet may be constructed of paperboard, cardboard, plastic or other such buoyant and inexpensive material.

Other variations, embodiments and features of the present invention will become evident from the following detailed description, drawings and claims.

### BRIEF DESCRIPTION OF THE DRAWINGS

FIG. 1 is a top view of a floating candle holder body of the present application;

FIG. 2 is a perspective view of a floating candle holder body and a candle exploded above the holder body prior to insertion into a central insertion aperture of the body;

FIG. 3 is a perspective view of an assembled floating candle holder body and candle;

FIG. 4 shows the assembled floating candle holder body and candle floating in a glass of liquid;

FIG. 5 is a bottom view of the floating candle holder body showing a magnet and printed bar code thereon;

FIGS. 6A-6C are top views of floating candle holder bodies of the present application with alternative outer profiles and central insertion apertures; and

FIGS. 7A-7C are flat patterns showing designs that may be used for embossing the candle holder bodies.

### DESCRIPTION OF THE PREFERRED EMBODIMENTS

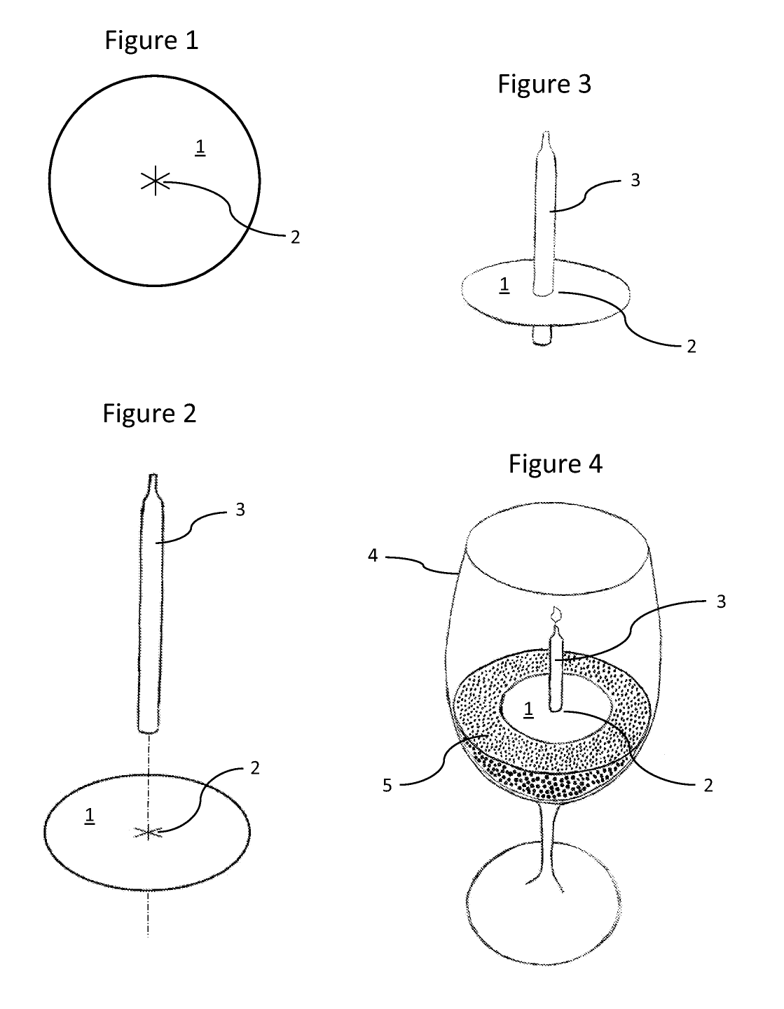

FIG. 1 is a top view of a floating candle holder of the present application having a holder body 1 and a candle insertion point 2. The illustrated holder body 1 comprises a relatively thin flat circular disk of a buoyant substrate as described below. The insertion point 2 in this embodiment comprises a plurality of straight cuts or score lines through the substrate from a top face to a bottom face. The illustrated embodiment shows 6 cuts intersecting at a central point, though more or less could be used. The holder body 1 preferably has a diameter that easily fits when floating on a beverage within a conventional 8-20 ounce glass, such as a wine glass, and thus is desirably between 2.0-3.0 inches in diameter. Of course, the receptacle or candle may be larger and the size of the corresponding holder body 1 increased accordingly. In one specific example the holder body 1 is 2.0 inches in diameter and the width of the candle insertion point 2 is about ¼ inch. Whatever the candle size, the central insertion point 2 has a distance across opposite sides (in this case the length of the score lines) smaller than the candle diameter so that when inserted therein the candle is gripped and held upright by the body.

FIG. 2 is a perspective view of the floating candle holder with a candle 3 exploded above the holder body 1 prior to insertion into the central insertion aperture 2. The candle 3 is shown as a relatively thin cylindrical type used for birthdays, though other shapes could also be used.

FIG. 3 shows the floating candle holder body 2 with the candle 3 assembled through the insertion aperture 2. FIG. 4 shows the assembled floating candle holder body 2 and candle 3 floating in a glass of liquid, in particular a wine glass. Although the present floating candle holder is most effective as an adornment for glasses of beverage, such as wine, it may also be used in other beverage or food item contexts, such as one or more of the candle holders in a punch bowl. Further, the floating candle holders may be used in bodies of water other than beverages, such as bathtubs, fountains or the like.

It should be noted that the thin flat candle holder body 2 floats on the top surface of the liquid in a horizontal plane so that the candle 3 is held in a vertical orientation. Of course, the configuration of the central insertion aperture 2 may be modified to permit the candle 3 to be held at an angle, the intent is to simply retain the candle 3 upright so that it may be lit from above.

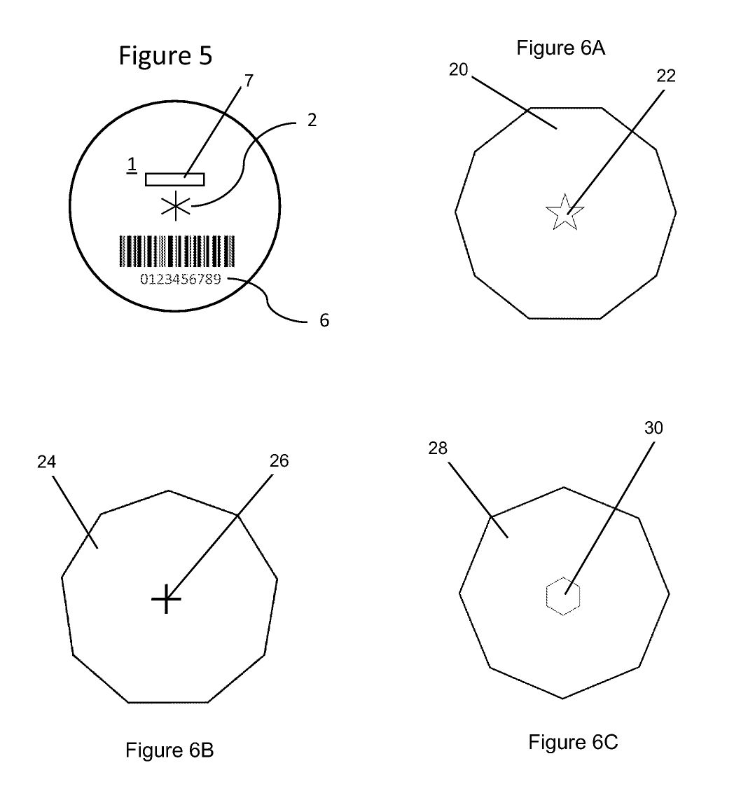

FIG. 5 is a bottom view of the floating candle holder body 1 showing a printed bar code 6 thereon. In this manner, the floating candle holder body 1 may be sold as is without extra packaging. Furthermore, the floating candle holder may double as a gift card with the bar code 6 having coded information as to the vendor and value of the gift card.

FIG. 5 also shows a small flat magnet 7 adhered to the bottom face of the candle holder body 1. The recipient of whatever honor prompts the presentation of the floating candle may desire to preserve the gesture, and the magnet 7 permits him or her to stick it to the refrigerator for display.

FIGS. 6A-6C are top views of floating candle holders of the present application with alternative outer profiles and central insertion apertures.

FIG. 6A shows a candle holder body 20 having a decagon-shaped outer profile. A central insertion point 22 is shaped as a star, with the star being cut through the substrate making up the body 20. The distance across opposite sides of the star shape of the central insertion point 22 may be sized slightly smaller than a cylindrical birthday candle so as to apply a gripping force thereto when the candle is inserted.

FIG. 6B shows a candle holder body 24 having a nonagon-shaped outer profile. A central insertion point 26 is shaped as a simple “plus” cut comprising two straight lines cut through the substrate making up the body 24. The distance across opposite sides of the hexagon of the central insertion point 22 may be sized slightly smaller than a cylindrical birthday candle so as to apply a gripping force thereto when the candle is inserted.

FIG. 6C shows a candle holder body 28 having an octagon-shaped outer profile. A central insertion point 30 is shaped as a hexagon cut through the substrate making up the body 28.

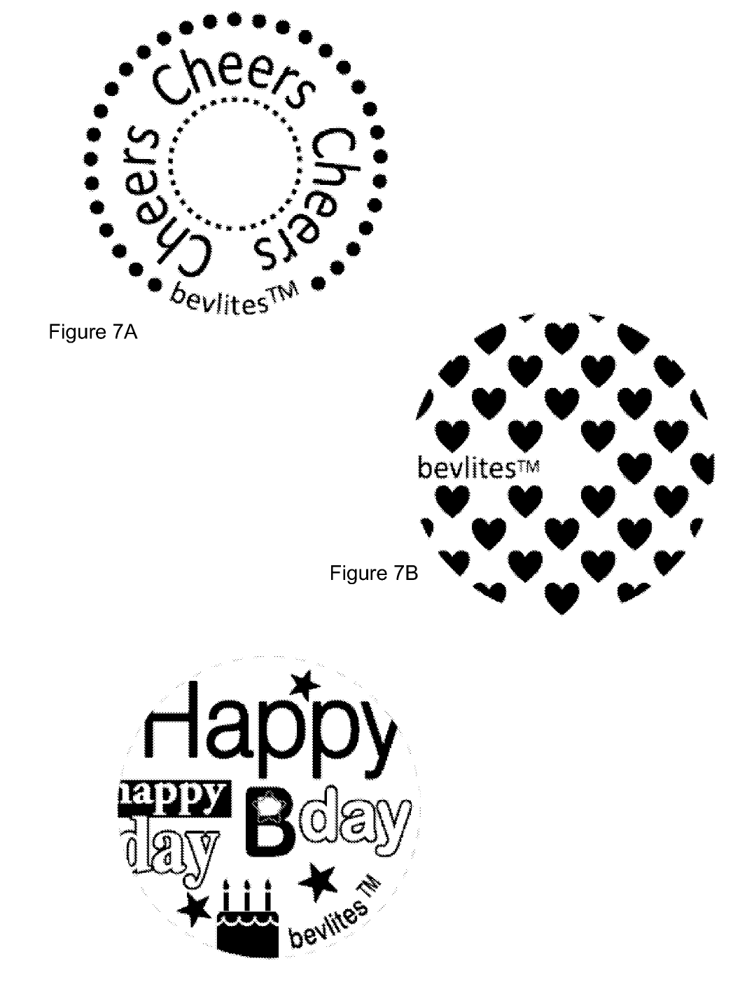

As mentioned, the top face of the candle holder body may have a printed or embossed message thereon, such as Happy Birthday, Congratulations, etc. FIGS. 7A-7C are flat patterns showing designs that may be used for embossing the candle holder bodies.

It should be understood that the outer profile of the candle holder body may be circular, polygonal, or another shape, but is desirably symmetric about at least perpendicular axes therethrough so that a candle inserted into the central insertion point is at a point of central buoyancy.

It should also be noted that although a flat disk-shaped candle holder is the primary embodiment, a holder body that is not entirely flat, such as having a slight concavity upward may also be used. That is, a flat disk pressed into a slight bowl shape with the central insertion point being the same may also work and not increase costs much. It is an advantage to keep the costs associated with making the candle holder down to make the final product extremely affordable.

Although the description focuses on a birthday candle embodiment, it should be apparent that the described device is capable of being used during any type of event or celebration. In addition, the device may support candles other than birthday candles. Typical “Birthday” candles typically measure between 2 and 2¾ inches in height with a diameter around 3/16 inches, although such dimensions may of course vary. For example, thin cylindrical birthday-style candles are available in ⅛, 3/16, ¼, 5/16, ⅜, 7/16, ½, and even larger sizes, though the present floating candle holders are most desirable for smaller sizes. The insertion point is preferably designed to grip onto a range of diameter candle. More particularly, the insertion point defining an aperture through the body from an upper face to a lower face through which a short length of the candle may be passed. The sides of the aperture defined by the shape of the insertion point flex outwards to a certain degree to apply a compressive holding force to the candle.

In each of these embodiments the central insertion point is located at a point of central buoyancy relative to the candle holder body, typically the geometric center of the outer profile. The substrate is desirably flat and has a thickness sufficient to firmly hold a birthday candle in the central insertion point. Of course, more than one insertion point may be provided, though in a balanced arrangement to maintain the substrate floating horizontal. Preferably the top face of the candle holder body has a printed or embossed message thereon, such as Happy Birthday, Congratulations, etc. Custom messages may also be added, or an array of common names for personalization. Another option is to provide a blank space for writing a personal message. Still further, a sheet of adhesive-backed photographic paper may be supplied along with the candle holder having an area for printing a photo that matches the shape of the candle holder body. The buyer simply prints out a picture on the photo paper, breaks out the area, which may be defined by score lines, and sticks it to the candle holder body. A knife may then be used to cut through the photo at the central insertion point.

A preferred form of substrate for the holders described herein is Milk Carton Stock or 20 point solid bleached sulphate (SBS) board. One particular such material is available from Badger Paperboard, Inc. of Fredonia, Wis. The Milk Carton Stock makes direct contact with food and is an FDA approved, food safe material. Packaging companies that work with food coming into direct contact with their materials have strict guidelines by which to abide. In the U.S., card stock thickness is usually measured in points or mils that gives the thickness of the sheet in thousandths of an inch. Therefore, a 20 pt. card is 0.020 in (0.508 mm) thick (roughly corresponding to a weight of 500 g/m²). The preferred substrate has a thickness of between 0.01-0.03 inches.

A preferred SBS grade is made purely from bleached chemical pulp and usually has a mineral or synthetic pigment coated top surface in one or more layers (C1S) and often also a coating on the reverse side (C2S). It is a medium density paper board with good printing properties for graphical and packaging end uses and is perfectly white both inside and out. It can easily be cut, creased, hot foil stamped and embossed. Its other properties, such as being hygienic and pure with no smell and taste, make it usable for packaging aroma and flavor sensitive products such as chocolate, cigarettes and cosmetics. Finally, the use of biodegradable materials is beneficial to avoid adding materials to the environment which will stick around in landfills for years.

The milk carton stock was primarily chosen because it is food safe and embosses well as to avoid using ink. The material also stays afloat with significant movement, does not catch fire in normal use in that it has a very low flammability, is relatively inexpensive, does not warp easily, has sufficient thickness, does not wick up to the sides of the glass as it does not rapidly absorb liquid, and is recyclable. Of course, other materials with some or all of these qualities may be substituted.

Aside from ink, foil can be used to apply designs to the substrate via printing, embossing, debossing or stamping.

A printed plastic or plastic coasted paper could be used so long as any health concerns or potential FDA issues are addressed. A printed plastic product may be cheaper but aside from the question of being food safe it has all of the other properties listed above for the paper board. Plastic also allows for printing colorful, attractive designs. Printing using ink versus embossing is preferred for the economics.

Another option is to coat both sides of a paper or other card stock with a food grade coating to seal printed artwork. This may be cost prohibitive but is also contemplated for the current candle holders.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

It is claimed:

1. A floating candle holder, comprising:
a thin flat candle holder body formed of a buoyant substrate having a central insertion point defining an aperture through the body from an upper face to a lower face, wherein the sides of the aperture defined by a shape of the insertion point flex outwards to apply a compressive holding force when a birthday candle having a predetermined diameter is inserted therethrough.

2. The floating candle holder of claim 1, wherein the substrate comprises a coated paperboard having a thickness of between 0.01-0.03 inches.

3. The floating candle holder of claim 1, wherein the substrate is milk carton stock.

4. The floating candle holder of claim 1, wherein the candle holder body has a circular outer profile.

5. The floating candle holder of claim 1, wherein the candle holder body has a polygonal outer profile.

6. The floating candle holder of claim 1, wherein the central insertion point comprises a series of intersecting score lines cut through the body from an upper face to a lower face.

8. The floating candle holder of claim 1, wherein the central insertion point comprises a geometric shape cut through the body from an upper face to a lower face and having a distance across opposite sides smaller than the predetermined diameter of the candle.

9. The floating candle holder of claim 1, further including a bar code printed on the lower face of the candle holder body.

10. The floating candle holder of claim 1, further including a magnet adhered on the lower face of the candle holder body.

11. A floating candle holder and candle combination, comprising:
a candle having a predetermined diameter; and
a thin flat candle holder body formed of a buoyant substrate having a central insertion point defining an aperture through the body from an upper face to a lower face, wherein the sides of the aperture defined by a shape of the insertion point flex outwards to apply a compressive holding force when the candle is inserted therethrough.

12. The combination of claim 11, wherein the substrate comprises a coated paperboard having a thickness of between 0.01-0.03 inches.

13. The combination of claim 11, wherein the substrate is milk carton stock.

14. The combination of claim 11, wherein the candle holder body has a circular outer profile.

15. The combination of claim 11, wherein the candle holder body has a polygonal outer profile.

16. The combination of claim 11, wherein the central insertion point comprises a series of intersecting score lines cut through the body from an upper face to a lower face.

17. The combination of claim 11, wherein the central insertion point comprises a geometric shape cut through the body from an upper face to a lower face and having a distance across opposite sides smaller than the predetermined diameter of the candle.

18. The combination of claim 11, further including a bar code printed on the lower face of the candle holder body.

19. The combination of claim 11, further including a magnet adhered on the lower face of the candle holder body.

20. The combination of claim 11, wherein the candle is a cylindrical birthday candle having a diameter of about around 3/16 inches.
